(19) United States
(12) Patent Application Publication
(10) Pub. No.: US 2025/0018351 A1
(43) Pub. Date: Jan. 16, 2025

(54) MIXING DEVICE FOR MIXING AT LEAST ANODE EXHAUST GAS AND CATHODE EXHAUST GAS FROM A FUEL CELL STACK OF A FUEL CELL SYSTEM

(71) Applicant: AVL List GmbH, Graz (AT)

(72) Inventor: Christoph SCHLUCKNER, Graz (AT)

(73) Assignee: AVL List GmbH, Graz (AT)

(21) Appl. No.: 18/712,746

(22) PCT Filed: Nov. 25, 2022
(86) PCT No.: PCT/AT2022/060416

§ 371 Date: May 23, 2024

(30) Foreign Application Priority Data
Nov. 25, 2021 (AT) A 50942/2021

(51) Int. Cl. B01F 25/313; B01F 23/10; B01F 25/10; B01F 101/00; H01M 8/04089

(52) U.S. Cl. CPC B01F 25/31331; B01F 23/19; B01F 25/103; B01F 25/104; B01F 25/3131; H01M 8/04089; B01F 2101/501

(57) ABSTRACT

The present invention relates to a mixing device (10) for mixing at least anode exhaust gas (AEG) with cathode exhaust gas (CEG) from a fuel cell stack (110) of a fuel cell system (100), having a cathode exhaust gas line (30) with a cathode exhaust gas connection (32) for fluid-communicating connection with a cathode exhaust gas section (134) of a cathode section (130) of the fuel cell stack (110) and an anode exhaust gas line (20) with an anode exhaust gas connection (22) for fluid-communicating connection with an anode exhaust gas section (124) of an anode section (120) of the fuel cell stack (110), characterised in that the anode exhaust gas line (20) is arranged within the cathode exhaust gas line (30) and has a closed anode exhaust gas line end (24) and at least two anode exhaust gas outlets (21) into the cathode exhaust gas line (30) with outlet directions (OD) radial to the anode exhaust gas line axis (AEL) and to the cathode exhaust gas line axis (CEL), wherein, further downstream of the anode exhaust gas line end (24), the cathode exhaust gas line (30) transitions into a mixed exhaust gas line (40) with a mixed exhaust gas connection (42) for fluid-communicating connection with a burner inlet (152) of an afterburner (150) of a fuel cell system (100).

The present invention relates to a mixing device for mixing at least anode exhaust gas and cathode exhaust gas from a fuel cell stack of a fuel cell system as well as a fuel cell system having such a mixing device.

It is known that, in fuel cell systems, electrical energy is generated from anode supply gas and cathode supply gas in a fuel cell stack by chemical conversion. Anode exhaust gas and cathode exhaust gas is thereby produced. It is also known for the exhaust gases from the fuel cell stack to be partially recirculated for further use. For example, part of the anode exhaust gas can be recirculated back in the direction of the fuel cell stack with the help of a conveyor device. This serves in particular to improve the efficiency of the fuel cell system as a whole. Another part of the anode exhaust gas is usually fed together with cathode exhaust gas to an afterburner, in which residues of chemically convertable components still present in the exhaust gas are combusted before the exhaust gas is released into the environment via a common exhaust gas discharge section.

A disadvantage of the known solutions is that the afterburner functionality depends on the respective operating situation, i.e. the respective gas quantities, the additional amount of fuel supplied, the residual fuel in the anode exhaust gas or fuel utilisation, the temperatures, the flow conditions and the like. This complex dependence means that in many operating situations the flow distribution and the mixing of anode exhaust gas and cathode exhaust gas, i.e. the local species concentration distribution upstream of the afterburner, is not sufficiently homogeneous. On the one hand, this leads to different temperature conditions and, accordingly, thermally introduced stresses up to irreversible thermomechanical damage within the afterburner, but above all to inhomogeneous post-combustion of the mixed exhaust gas.

It is the object of the present invention to remedy, at least in part, the disadvantages described above. In particular, the object of the present invention is to provide, in a cost-effective and simple manner, the most homogeneous combustion possible in the afterburner for as many operating ranges of the fuel cell system as possible.

The above object is achieved by a mixing device with the features of claim 1, as well as a fuel cell system with the features of claim 15. Further features and details of the invention are disclosed in the dependent claims, the description and the drawings. Naturally, features and details described in connection with the mixing device according to the invention also apply in connection with the fuel cell system according to the invention and vice versa, so that with regard to disclosure mutual reference is or can always be made to the individual aspects of the invention.

According to the invention, a mixing device is used to mix at least anode exhaust gas with cathode exhaust gas from a fuel cell stack of a fuel cell system. For this purpose, the mixing device has a cathode exhaust gas line with a cathode exhaust gas connection for fluid-communicating connection with a cathode exhaust gas section of a cathode section of the fuel cell stack. The mixing device is also equipped with an anode exhaust gas line with an anode exhaust gas connection for fluid-communicating connection with an anode exhaust gas section of an anode section of the fuel cell stack of the fuel cell system. The mixing device according to the invention is characterised in that the anode exhaust gas line is arranged within the cathode exhaust gas line and has a closed anode exhaust gas line end and at least two anode exhaust gas outlets into the cathode exhaust gas line, with outlet directions radial to the anode exhaust gas line axis and to the cathode exhaust gas line axis. Further downstream of the anode exhaust gas line end, the cathode exhaust gas line transitions into a mixed exhaust gas line, with a mixed exhaust gas connection for fluid-communicating connection with a burner inlet of an afterburner of a fuel cell system.

The core idea of the invention is based on improving the mixing functionality between the anode exhaust gas and the cathode exhaust gas and in particular to homogenise this over as many operating ranges of the fuel cell system as possible. This is achieved in that a defined geometrical correlation is provided within the mixing device for the introduction of the anode exhaust gas into the flow of the cathode exhaust gas. The result is that, along the outlet directions radial to the anode exhaust gas line axis and also radial to the cathode exhaust gas line axis, the anode exhaust gas is also introduced into the cathode exhaust gas radially and thus transversely to the main flow direction of the cathode exhaust gas in the cathode exhaust gas line. At the point of introduction directly after the anode exhaust gas outlets, the anode exhaust gas thus flows with its flow direction transverse to the flow direction of the cathode exhaust gas, so that a significantly improved mixing takes place due to the angular confluence of these two exhaust gas flows. This improved mixing leads to a more homogeneous intermixing of cathode exhaust gas and anode exhaust gas during the formation of the resulting mixed exhaust gas. Moreover, this homogenisation takes place over a shorter mixing section, which can also be understood as a mixing path. This mixing path is the length over which the mixing of anode exhaust gas and cathode exhaust gas takes place after the anode exhaust gas has flowed in. The shorter this mixing path is, the shorter and thus more compact the mixing device according to the invention can be.

As can be seen from the above explanation, it is now possible to mix the anode exhaust gas of a fuel cell stack with the cathode exhaust gas in a known manner. According to the invention, this is now improved by correlating the flow direction along the cathode exhaust gas line axis and the outlet direction of the anode exhaust gas outlets in such a way that the mixing path is reduced and homogenisation is enhanced. In other words, the design of the mixing device according to the invention leads to a more homogeneous mixing of anode exhaust gas and cathode exhaust gas being provided over a shorter mixing path.

As a result, despite a more compact design of the mixing device, a very homogeneous composition of the mixed exhaust gas is supplied to the downstream afterburner. This particularly homogeneous composition of the mixed exhaust gas leads to corresponding homogeneous afterburner functionality within the afterburner, so that the described disadvantages of inhomogeneous mixing ratios can be eliminated or at least significantly reduced.

According to the invention, the individual lines, i.e. the cathode exhaust gas line, the anode exhaust gas line and the mixed exhaust gas line, are used to carry the respective exhaust gas. For this purpose, the individual lines are designed with corresponding outer walls which perform this guiding function. The simplest possible design is achieved if the individual lines have a round or substantially round cross-section.

It should also be noted that, in the context of the invention, an outlet direction radial to the respective line axes is to be understood as any direction which is in particular not aligned parallel to the respective line axis. Thus, such a radial alignment also includes acute-angled alignments, as will be explained in more detail later. In particular, the outlet directions have an outlet angle relative to the respective line axis in the range between approx. 20° and approx. 70°.

It should also be noted that, in the context of the invention, the anode exhaust gas outlets are preferably arranged on a common circumferential ring or on several common circumferential rings. Arranging two or more anode exhaust gas outlets together on a common circumferential ring leads to a further reduction of the extension in length of the mixing device and thus to a further increased compactness of the mixing device according to the invention.

In addition to the introduction and mixing of anode exhaust gas and cathode exhaust gas, other additional gases, such as, in particular, fuel, as will be explained later, and/or an additional supply of air, can of course also be provided in the cathode exhaust gas. This complements the core idea described above to include a homogeneous mixing with these other gases.

It should also be noted that the individual lines may have separate connection pipes. If, for example, the anode exhaust gas line is integrated coaxially into the cathode exhaust gas line, then the anode exhaust gas line will be led to the outside through the wall of the cathode exhaust gas line via a curved supply section in order to ensure the desired fluid-communicating connection with the anode exhaust gas section.

It is particularly advantageous if the mixing device is designed and arranged to mix anode exhaust gas, additional fuel and cathode exhaust gas. The additional fuel is in particular gaseous and can, for example, be ethanol, natural gas, LPG or another liquid or gaseous carbonaceous fuel. Basically, it is advantageous if the fuel is the same fuel that is provided for use in the anode section of the fuel cell stack. It can also be advantageous if all the fuel which is chanelled in the direction of the anode section is channeled to it via the mixing device, i.e. it is in particular mixed with a recirculated anode exhaust gas.

It can bring advantages if, in a mixing device according to the invention, upstream of the anode exhaust gas outlets a fuel line is arranged around the anode exhaust gas line, in particular in an annular manner, with a fuel connection for fluid-communicating connection with a fuel section of the fuel cell system. The fuel line is provided with at least two fuel outlets with outlet directions radial to the anode exhaust gas line axis and to the cathode exhaust gas line axis. As has already been explained, it should be ensured that the mixed exhaust gas is mixed as homogeneously as possible, preferably for all or a large number of operating conditions. The aim of this homogeneous mixing is in particular to achieve the most efficient possible operation of the afterburner and to suppress local ignition zones and/or flame formation. If, for example, a start-up operation of the fuel cell system is taking place, a key aspect in terms of efficiency in start-up mode is to increase the temperature to the desired stationary operating temperature for the fuel cell system. In the case of SOFC fuel cell systems, this can lie in the range of up to 1000 C°. In addition to an initial start-up phase, which is often provided by an electric heater, as the fuel cell system continues to heat up, additional fuel such as ethanol, methane, natural gas or similar hydrocarbons or hydrogen in vaporous or gaseous form can now be introduced into the cathode exhaust gas of the mixing device via the fuel line described in this embodiment. At this point, in the mode of operation of the fuel cell stack, very little fuel is still contained in the anode exhaust gas. In order nonetheless to achieve the most homogeneous combustion possible in the afterburner, and in particular to achieve a high heat development in the afterburner, an additional and homogeneous mixing of the cathode exhaust gas with the additionally supplied fuel can now be ensured in a similar way with the help of the fuel connection and the fuel line. This ensures a higher calorific value in the mixed exhaust gas with homogeneous distribution, so that a higher heat release in the afterburner is possible. The additional heat generated in this way can, for example, be transferred to supply gases in supply sections of the fuel cell stack via one or more heat exchangers. This means that this heat can be fed into the fuel cell stack with the supply gases and heat this up. This fuel line can for example be integrated into the wall of the exhaust gas line. For example, an annular and circumferential thickening of the anode exhaust gas line can have an integrated annular cavity which is passed through the wall of the cathode exhaust gas line to the outside with a lateral connection.

This design of the mixing device makes it possible to minimise locally occurring mixing zones of anode exhaust gas, fuel gas and cathode exhaust gas and thus to prevent or at least minimise any ignition of the anode exhaust gas on passing through ignition limits due to zones of local turbulence. Furthermore, this design of the mixing device actively reduces the stratification of anode exhaust gas or fuel gas in the cathode exhaust gas. Stratification can primarily occur due to laminar flow conditions or flow regimes in the transitional range during different operating ranges (such as a partial load operation in particular).

It is also advantageous if, in a mixing device according to the invention, downstream of the anode exhaust gas outlets, the anode exhaust gas line end has a dead space displacement volume, in particular in teardrop form or substantially in teardrop form, in order to reduce stagnation and recirculation zones in the mixed exhaust gas line. After the anode exhaust gas has flowed into the cathode exhaust gas, mixing takes place over a mixing path to form the mixed exhaust gas, as has already been explained. Immediately after the inflow, a complex flow situation occurs during mixing. If a recess or an abrupt end is provided at this location as the anode exhaust gas line end, this can represent a dead volume from a flow viewpoint or can even lead to recirculation. These are undesirable for a variety of reasons. Depending on the concentration of fuel and the temperature, a flame can be formed which assumes a stationary form and stabilises due to recirculation and is undesirable at this position. The undesirable recirculation zone acts as a flame holder or flame anchor. Also, any recirculation here leads to even more complex flow conditions and can lead to an undesirable in homogenisation of the mixed exhaust gas. The introduction of a dead space displacement volume in order to displace this dead space thus leads to a smaller dead space and accordingly to fewer flow separations and recirculation possibilities. Also, in this way a volume is filled which is no longer available for undesirable flame formation in this region. The design of the dead space displacement volume in a teardrop shape, in particular tapering to a point along the flow direction of the mixed exhaust gas, leads to an improved formation of this dead space displacement volume, so that this effect can be achieved in an optimal manner. To further reduce the weight and thermal inertia of the mixing device, this dead space displacement volume can be designed with a cavity. In order to avoid undesirable stresses from a mechanical point of view where a cavity is provided, this cavity may have a small pressure equalisation opening, in particular at its tip, in order to avoid or at least reduce mechanical stresses in the event of pressure differences and/or temperature differences.

It is also advantageous if, in a mixing device according to the invention, the extension of the dead space displacement volume along the cathode exhaust gas line axis and along the anode exhaust gas line axis corresponds to or substantially corresponds to the joint extension of the cathode exhaust gas line and the anode exhaust gas line.

After the introduction of anode exhaust gas into the anode exhaust gas line and cathode exhaust gas into the cathode exhaust gas line, these run in particular coaxially to each other, as will be explained later. Over this distance, the flow direction in the cathode exhaust gas line and in the anode exhaust gas line is homogenised in order to achieve the desired mixing effect, in a predefined manner, with the radial outlet direction at the anode exhaust gas outlets. In order to reduce recirculation and dead space as far as possible, the dead space displacement volume also extends over the same length or substantially the same length over which cathode exhaust gas lines and anode exhaust gas lines run parallel to each other and coaxially. This ensures that, in the same way as the harmonisation of flow conditions prior to mixing, the avoidance of recirculation after mixing is guaranteed.

In addition, it may be advantageous if, in a mixing device according to the invention, flow guide surfaces are arranged in the cathode exhaust gas line upstream, downstream and/or in the region of the anode exhaust gas outlets, in a circumferential direction around the anode exhaust gas line, in order to generate a flow rotation of the cathode exhaust gas. In order to further increase the mixing functionality of the mixing device according to the invention, an additional rotational motion in the form of a rotational impulse can be introduced into the cathode exhaust gas. This is effected by means of one or more flow guide surfaces which impart the flow rotation to the cathode exhaust gas either before reaching the anode exhaust gas outlets, on reaching the anode exhaust gas outlets or already in the mixing state downstream of the anode exhaust gas outlets. This makes it possible to homogenise the mixing even more effectively and, in particular, to further shorten the mixing path, which has already been mentioned several times, and to prevent or suppress local flame formation or ignition of the anode exhaust gas. In addition, it may be possible to provide the mixing zones with turbulent flow conditions by introducing a flow rotation, so that an even more pronounced mixing function is provided. The flow guide surfaces can be integrated separately into the cathode exhaust gas line as separate components. Preferably, however, they are formed as part of the inner wall of the cathode exhaust gas line and/or as part of the outer wall of the anode exhaust gas line. They can be blade-like or planar surfaces oriented transversely to the respective line axis and in this way impart a rotational impulse to the cathode exhaust gas and/or the mixed exhaust gas.

It can bring further advantages if, in the mixing device according to the preceding paragraph, the flow guide surfaces of are static in design. A static design means that the flow guide surfaces do not move relative to the anode exhaust gas line and the cathode exhaust gas line. Rather, they are firmly defined in terms of their position and rotation and are, accordingly, mounted so as to be free of movement. Due to the fact that no moving part bearings are necessary, they are particularly wear-resistant and can in particular be integrated into the mixing device according to the invention without any need for maintenance. The related costs and the associated complexity of the design are also kept particularly low in this way.

Mixing devices according to the preceding paragraph may be further developed to the effect that the flow guide surfaces are evenly or substantially evenly distributed in a circumferential direction and that the number of flow guide surfaces corresponds in particular to the number of anode exhaust gas outlets or a multiple thereof. An even distribution, in turn, leads to a further homogenisation of the mixing functionality. The correlation of the number of flow guide surfaces with the number of anode exhaust gas outlets also represents a further homogenisation, since an associated rotational impulse can be introduced into the cathode exhaust gas per anode exhaust gas inlet. Of course, this number, in particular a multiple of this number, can also be used where the anode exhaust gas outlets and/or the flow guide surfaces are arranged in stages.

It is also advantageous that, in the case of a mixing device with flow guide surfaces, these have an angular orientation in the direction of the cathode exhaust gas line axis and overlap, at least in sections. In this way, a direct throughflow without the flow being influenced by the flow guide surfaces is excluded or substantially excluded. In other words, a 100% or complete influencing of the cathode exhaust gas takes place, so that, as a result of the angular orientation according to the invention, the rotational impulse is completely transferred to the cathode exhaust gas flowing through. This overlap can be provided either by correspondingly long flow guide surfaces or by a correspondingly large number thereof.

It is also advantageous if, in such a mixing device according to the invention, at least two stages of flow guide surfaces are arranged along the cathode exhaust gas line axis. In other words, two or more different stages of flow guide surfaces distributed in a circumferential direction are arranged in the cathode exhaust gas line. The individual stages are in particular identical, but differ in their geometrical characteristics. For example, the individual stages can have different lengths or a different number of flow guide surfaces. Preferably, the number of stages of flow guide surfaces corresponds to the number of stages of a multi-stage design of the anode exhaust gas outlets.

It is also advantageous if, in a mixing device according to the invention, the anode exhaust gas outlets are arranged on at least one common circumferential section of the anode exhaust gas line. This can be a single circumferential section or several circumferential sections, so that two or more outlet rings are formed by the anode exhaust gas outlets. Preferably, the opening cross-sections for all anode exhaust gas outlets of such an outlet ring are identical. For different outlet rings, the anode exhaust gas outlets can also have different opening cross-sections. As has already been explained, the number of circumferential sections, and thus the number of outlet rings, preferably corresponds to the number of stages of the flow guide surfaces described above.

Further advantages can be achieved if, in a mixing device according to the invention, the mixed exhaust gas line is designed without a diffuser. A diffuser is usually used to provide further pressure influencing and/or homogenisation of the gas contained therein. Due to the fact that, according to the invention, the mixing now already takes place with a strong homogenising effect over a short mixing path, a diffuser can be dispensed with in such a mixing device according to the present invention. Since such diffusers are usually relatively long, the design without a diffuser leads to an even more compact construction of this mixing device.

It is also advantageous if, in a mixing device according to the invention, the anode exhaust gas outlets have, at least in part, an outlet direction oriented at an acute angle to the anode exhaust gas line axis and/or to the cathode exhaust gas line axis. This makes it possible, so to speak, to introduce the anode exhaust gas into the cathode exhaust gas at an acute angle, so that the cross-flow effect for the homogenising effect during mixing can still be achieved, but the pressure loss is reduced. Furthermore, local recirculation zones below, i.e. locally downstream of the anode exhaust gas outlets, are minimised, and flame holders are effectively prevented, as described above. Improved mixing with increased homogeneity is thus achievable with higher efficiency when operating the mixing device.

It is also advantageous if, in a mixing device according to the invention, outlet guide surfaces are arranged within the anode exhaust gas line to influence the flow of anode exhaust gas into and/or through the anode exhaust gas outlets. Here, too, it becomes possible to further influence the flow conditions for the mixing of anode exhaust gas and cathode exhaust gas. For example, independently of the pure outlet direction of the anode exhaust gas outlets, an additional influencing of the flow through the anode exhaust gas outlets can be achieved. This can range from a variation of the direction, an application of a rotational impulse to the anode exhaust gas, to an acceleration function for the passage of the anode exhaust gas through the outlets. Here, too, it becomes possible to further enhance the homogenisation effect and, in particular, to further reduce the length of the mixing path.

It can also be advantageous if, in a mixing device according to the invention, the anode exhaust gas line and the cathode exhaust gas line are aligned coaxially or substantially coaxially, at least in the region of the anode exhaust gas outlets. This means a particularly compact arrangement, since the anode exhaust gas line can be substantially fully integrated into the cathode exhaust gas line. In particular, this is combined with substantially round flow cross-sections for the individual lines.

The subject matter of the present invention also includes a fuel cell system for generating electricity from fuel. Such a fuel cell system has a fuel cell stack with an anode section and a cathode section. The anode section is equipped with an anode supply section for the supply of anode supply gas and with an anode exhaust gas section for the discharge of anode exhaust gas. The cathode section is equipped with a cathode supply section for the supply of cathode supply gas and with a cathode exhaust gas section for the discharge of cathode exhaust gas. Furthermore, such a fuel cell system has an exhaust gas discharge section for the discharge of mixed exhaust gas consisting of anode exhaust gas and cathode exhaust gas into the environment via an afterburner. Such a fuel cell system is characterised in that a mixing device according to the present invention is arranged in the exhaust gas discharge section upstream of the afterburner. Thus, a fuel cell system according to the invention brings the same advantages as have been explained in detail with reference to a mixing device according to the invention. Such a fuel cell system is in particular designed as a high-temperature fuel cell system, for example as a so-called SOFC fuel cell system. The afterburner is in particular a catalytic burner which provides an afterburner function for the fuel cell system. This leads to an at least partial combustion of the mixed exhaust gas in the post-treatment for this mixed exhaust gas.

Further advantages, features and details of the invention are explained in the following description, in which exemplary embodiments of the invention are described in detail with reference to the drawings. In each case schematically:

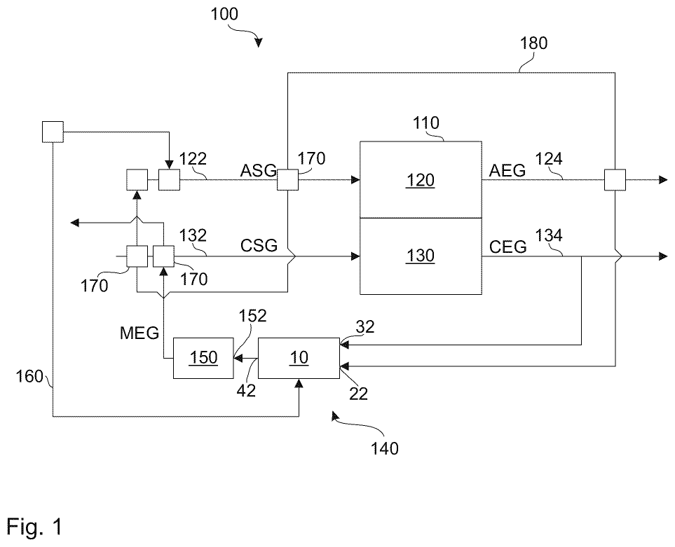

FIG. 1 shows an embodiment of a fuel cell system according to the invention,

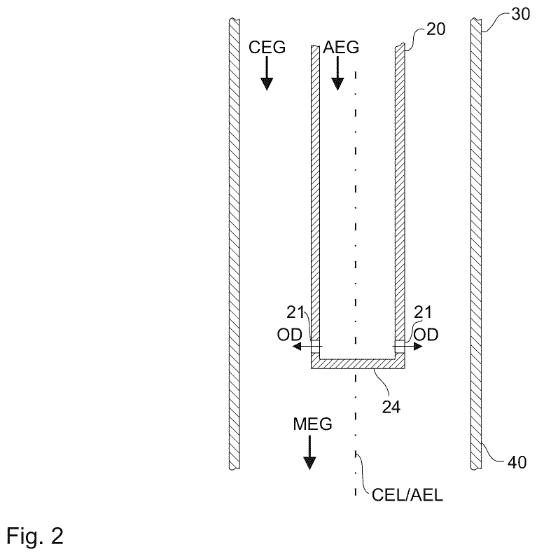

FIG. 2 shows an embodiment of a mixing device according to the invention,

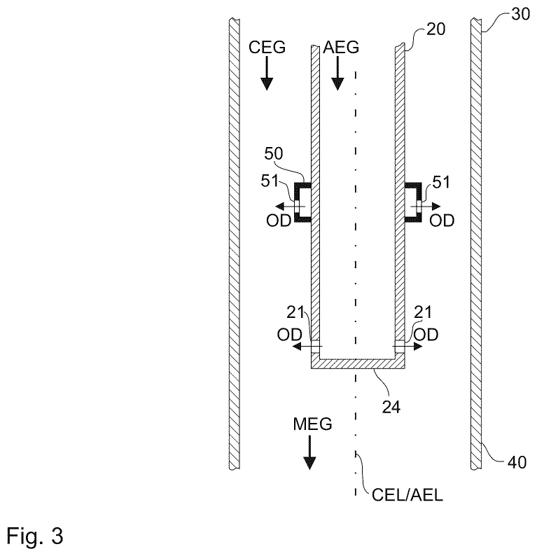

FIG. 3 shows a further embodiment of a mixing device according to the invention,

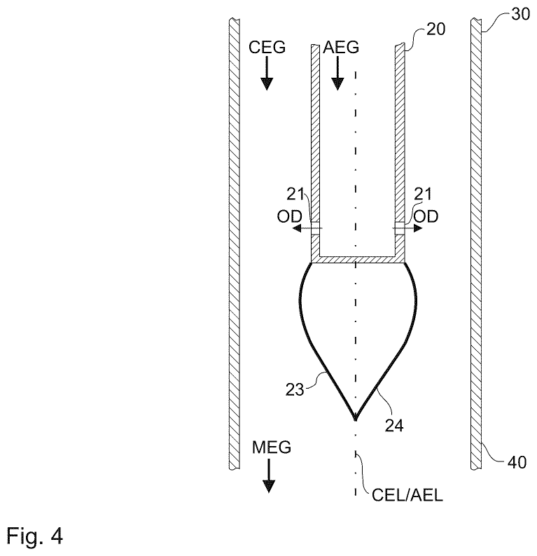

FIG. 4 shows a further embodiment of a mixing device according to the invention,

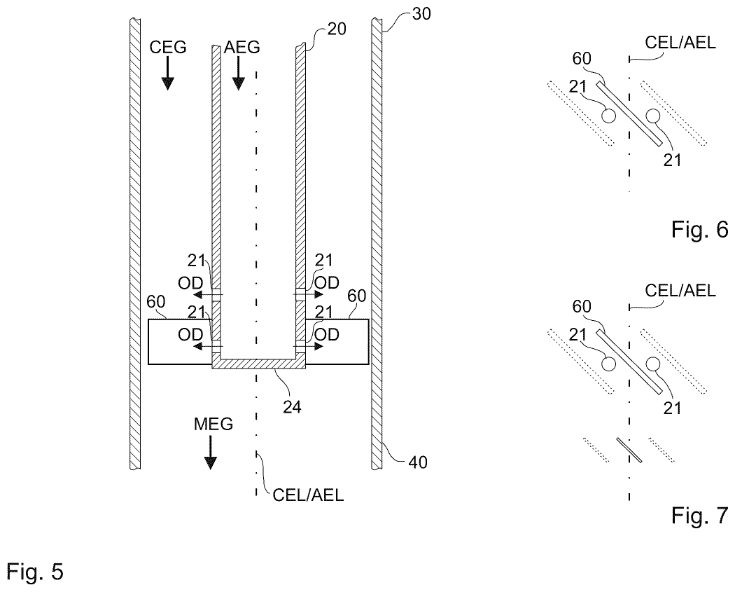

FIG. 5 shows a further embodiment of a mixing device according to the invention,

FIG. 6 shows a partial representation of the embodiment of FIG. 5,

FIG. 7 shows an alternative to the embodiment of FIG. 6,

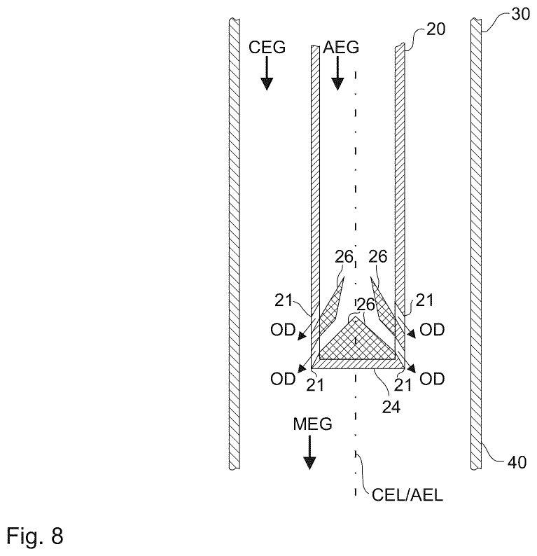

FIG. 8 shows a further embodiment of a mixing device according to the invention.

FIG. 1 shows schematically how a fuel cell system 100 according to the present invention can be equipped. For reasons of efficiency, not all elements of a fuel cell system 100 are shown, for example heat exchangers, conveying device and/or reformers and other elements.

For the conversion of fuel in the anode supply gas ASG, a fuel cell stack 110 is supplied with the anode supply gas ASG via the anode supply section 122. This flows into the anode section 120 of the fuel cell stack 110, where it is converted, and the anode exhaust gas AEG which is produced is discharged from the anode section 120 via the anode exhaust gas section 124. Parallel to this, cathode supply gas CSG, for example air, is supplied to the cathode section 130 via a cathode supply section 132. The cathode exhaust gas CEG, which is also produced during the reaction of the cathode supply gas CSG with the anode supply gas ASG, is discharged from the cathode section 130 via the cathode exhaust gas section 134.

It can be seen from FIG. 1 that this fuel cell system 100 is provided with a recirculation function by means of a recirculation section 180. In the recirculation section 180, anode exhaust gas AEG is conveyed again in the direction of the anode supply section 122, for which purpose a conveying device such as a fan or an ejector, not shown in FIG. 1, is provided. Heat can be recovered from the recirculated anode exhaust gas AEG via heat exchangers 170 in the anode supply section 122 and the cathode supply section 132.

Furthermore, an exhaust gas discharge section 140 is provided for the discharge of mixed exhaust gas MEG into the environment. This takes place via an afterburner 150. In the embodiment shown in FIG. 1, a mixing device 10 according to the invention is integrated into this exhaust gas discharge section 140. This collects anode exhaust gas AEG via an anode exhaust gas connection 22 and cathode exhaust gas CEG via a cathode exhaust gas connection 32. After mixing, mixed exhaust gas MEG is provided via a mixed exhaust gas connection 42 to a burner inlet 152 of the afterburner 150. In this representation, it can in addition be seen that fuel in the form of the anode supply gas ASG can also be supplied to the mixing device 10. Details regarding the possible design of a mixing device 10 can be found in the following figures.

FIG. 2 shows a particularly simple solution of a mixing device 10 according to the invention. Here, an anode exhaust gas line 20 is integrated coaxially into a cathode exhaust gas line 30. These are coaxially aligned with each other, so that the cathode exhaust gas line axis CEL coincides with the anode exhaust gas line axis AEL. As a result, anode exhaust gas AEG can now be conducted within the anode exhaust gas line 20 and can only exit at the anode exhaust gas line end 24, in a radial direction to the left and right, through the anode exhaust gas outlets 21. The outlet direction OD at these anode exhaust gas outlets 21 is substantially transverse to the flow direction of the cathode exhaust gas CEG in the cathode exhaust gas line 30. This leads to the homogenising mixing of anode exhaust gas AEG and cathode exhaust gas CEG to form the mixed exhaust gas MEG, already explained several times, which is now discharged together in the mixed exhaust gas line 40 into which the cathode exhaust gas line 30 transitions.

FIG. 3 shows a further development of the embodiment of FIG. 2. Here, a possibility is provided as has already been explained in FIG. 1, namely the supply of additional vaporous or gaseous fuel. Fuel can be supplied via a fuel line 50, which is arranged here in a ring around the anode exhaust gas line 20. This also exits in a radial direction through fuel outlets 51, whose outlet directions OD thus have the same functionality transverse to the flow direction of the cathode exhaust gas CEG and thus also lead to a homogeneous mixing of the fuel with the cathode exhaust gas CEG. This leads to a heating-up functionality during the heat-up process for the fuel cell system 100.

FIG. 4 shows a possibility for minimising recirculation zones and dead spaces. This is fundamentally based on the embodiment of FIG. 2. Here one can see a substantially teardrop-shaped design of a dead space displacement volume 23 as anode exhaust gas line end 24. This dead space displacement volume 23 is provided with a hollow interior, in particular with a small opening, not represented in detail, in order to avoid mechanical stresses in the wall of the dead space displacement volume and at the same time to ensure the lightest possible construction. This dead space displacement volume 23 is arranged in the area which poses the highest risk of dead space or a recirculation of mixed exhaust gas MEG. Due to the displacement of the dead space, the result is that substantially no recirculation takes place, but after the homogeneous mixing of the cathode exhaust gas CEG and anode exhaust gas AEG this is continuously transported away together as mixed exhaust gas MEG via the mixed exhaust gas line 40.

FIG. 5 also shows a further development of the embodiment of FIG. 2. Two circumferential rings of anode exhaust gas outlets 21 are shown here, whereby the lower ring of anode exhaust gas outlets 21 is in addition equipped with a stage of flow guide surfaces 60. These are also shown in more detail in the transverse view in FIG. 6 and are here substantially planar or plate-formed flow guide surfaces 60. These overlap along the direction of flow or along the cathode exhaust gas line axis CEL, so that a substantially complete influencing and transfer of a rotational impulse to the cathode exhaust gas CEG is possible. The lower ring of anode exhaust gas outlets 21 is integrated here into the gaps between the flow guide surfaces 60 in order to further enhance the functionality for the homogenisation of the different exhaust gases. FIG. 7 shows a further development of the embodiment of FIG. 6. Here, a downstream second stage for rotational influence in the same direction with correspondingly smaller flow guide surfaces 60 is shown. Of course, additional anode exhaust gas outlets 21 (not shown) in the form of an additional outlet ring can also be provided here.

FIG. 8 also shows a further development of the embodiment of FIG. 2. Here, outlet guide surfaces 26 are in addition integrated into the anode exhaust gas line 20. In its interior, the flow of the anode exhaust gas AEG is now influenced before, or for, the passage through the anode outlet openings 21. It can also be clearly seen here that the outlet directions OD are oriented at an acute angle to the cathode exhaust gas line axis CEL and to the anode exhaust gas line axis AEL. In this way too, it becomes possible to achieve an even greater homogenisation and shortening of the mixing path.

The embodiments described above describe the present invention exclusively in the context of examples.

### LIST OF REFERENCE SIGNS

10 mixing device
20 anode exhaust gas line
21 anode exhaust gas inlet
22 anode exhaust gas connection
23 dead space displacement volume
24 anode exhaust gas line end
26 outlet guide surface
30 cathode exhaust gas line
32 cathode exhaust gas connection
40 mixed exhaust gas line
42 mixed exhaust gas connection
50 fuel line
51 fuel outlet
52 fuel connection
60 flow guide surface
100 fuel cell system
110 fuel cell stack
120 anode section
122 anode supply section
124 anode exhaust gas section
130 cathode section
132 cathode supply section
134 cathode exhaust gas section
140 exhaust gas discharge section
150 afterburner
152 burner inlet
160 fuel section
170 heat exchanger
180 recirculation section
OD outlet direction
AEL anode exhaust gas line axis
CEL cathode exhaust gas line axis
ASG anode supply gas
AEG anode exhaust gas
CSG cathode supply gas
CEG cathode exhaust gas
MEG mixed exhaust gas

1. Mixing device for mixing at least anode exhaust gas (AEG) with cathode exhaust gas (CEG) from a fuel cell stack of a fuel cell system, having a cathode exhaust gas line with a cathode exhaust gas connection for fluid-communicating connection with a cathode exhaust gas section of a cathode section of the fuel cell stack and an anode exhaust gas line with an anode exhaust gas connection for fluid-communicating connection with an anode exhaust gas section of an anode section of the fuel cell stack, wherein the anode exhaust gas line is arranged within the cathode exhaust gas line and has a closed anode exhaust gas line end and at least two anode exhaust gas outlets into the cathode exhaust gas line with outlet directions (OD) radial to the anode exhaust gas line axis (AEL) and to the cathode exhaust gas line axis (CEL), wherein, further downstream of the anode exhaust gas line end, the cathode exhaust gas line transitions into a mixed exhaust gas line with a mixed exhaust gas connection for fluid-communicating connection with a burner inlet of an afterburner of a fuel cell system.

2. Mixing device according to claim 1, wherein, upstream of the anode exhaust gas outlets a fuel line is arranged around the anode exhaust gas line, in particular in an annular manner, with a fuel connection for fluid-communicating connection with a fuel section of the fuel cell system, wherein the fuel line has at least two fuel outlets with outlet directions (OD) radial to the anode exhaust gas line axis (AEL) and to the cathode exhaust gas line axis (CEL).

3. Mixing device according to claim 1, wherein, downstream of the anode exhaust gas outlets, the anode exhaust gas line end has a dead space displacement volume, in particular in teardrop form or substantially in teardrop form, in order to reduce the dead space in the mixed exhaust gas line.

4. Mixing device according to claim 3, wherein the extension of the dead space displacement volume along the cathode exhaust gas line axis (CEL) and along the anode exhaust gas line axis (AEL) corresponds to or substantially corresponds to the joint extension of the cathode exhaust gas line and the anode exhaust gas line.

5. Mixing device according to claim 1, wherein flow guide surfaces are arranged in the cathode exhaust gas line upstream, downstream and/or in the region of the anode exhaust gas outlets, in a circumferential direction around the anode exhaust gas line, in order to generate a flow rotation of the cathode exhaust gas (CEG).

6. Mixing device according to claim 5, wherein the flow guide surfaces are static in design.

7. Mixing device according to claim 5, wherein the flow guide surfaces are evenly or substantially evenly distributed in a circumferential direction and the number of flow guide surfaces corresponds in particular to the number of anode exhaust gas outlets or a multiple thereof.

8. Mixing device according to claim 5, wherein the flow guide surfaces have an angular orientation in the direction of the cathode exhaust gas line axis (CEL) and overlap, at least in sections.

9. Mixing device according to claim 5, wherein at least two stages of flow guide surfaces are arranged along the cathode exhaust gas line axis (CEL).

10. Mixing device according to claim 1, wherein the anode exhaust gas outlets are arranged on at least one common circumferential section of the anode exhaust gas line.

11. Mixing device according to claim 1, wherein the mixed exhaust gas line is designed without a diffuser.

12. Mixing device according to claim 1, wherein the anode exhaust gas outlets have, at least in part, an outlet direction (OD) oriented at an acute angle to the anode exhaust gas line axis (AEL) and/or to the cathode exhaust gas line axis (CEL).

13. Mixing device according to claim 1, wherein outlet guide surfaces are arranged within the anode exhaust gas line to influence the flow of anode exhaust gas (AEG) into and/or through the anode exhaust gas outlets.

14. Mixing device according to claim 1, wherein the anode exhaust gas line and the cathode exhaust gas line are aligned coaxially or substantially coaxially, at least in the region of the anode exhaust gas outlets.

15. Fuel cell system for generating electricity from fuel, having a fuel cell stack with an anode section and a cathode section, the anode section having an anode supply section for the supply of anode supply gas (ASG) and an anode exhaust gas section for the discharge of anode exhaust gas (AEG), the cathode section having a cathode supply section for the supply of cathode supply gas (CSG) and a cathode exhaust gas section for the discharge of cathode exhaust gas (CEG), further having an exhaust gas discharge section for the discharge of mixed exhaust gas (MEG) consisting of anode exhaust gas (AEG) and cathode exhaust gas (CEG) into the environment via an afterburner, wherein a mixing device with the features of claim 1 is arranged in the exhaust gas discharge section upstream of the afterburner.
